(19) United States
(12) Patent Application Publication
(10) Pub. No.: US 2018/0130104 A1
(43) Pub. Date: May 10, 2018

(54) SYSTEMS AND METHODS FOR DYNAMIC, ATTRIBUTE BASED PRICE SETTING FOR DELIVERY AND FULFILLMENT FEES FOR ONLINE AND OFFLINE ORDERS AND USER OFFER REVIEWS

(71) Applicant: YUMMY FOODS, LLC, Los Angeles, CA (US)

(72) Inventor: Barnaby Montgomery, Pasadena, CA (US)

(21) Appl. No.: 15/685,904

(22) Filed: Aug. 24, 2017

Related U.S. Application Data
(60) Provisional application No. 62/379,200, filed on Aug. 24, 2016.

(51) Int. Cl. G06Q 30/04

(52) U.S. Cl. CPC G06Q 30/04; G06Q 30/0601

(57) ABSTRACT

Systems, devices, and methods are provided for providing dynamic, customizable fee structure selections to customers using a computer network based merchandise store using a computer including customer offer reviews and reduced searching time for products.

### CROSS-REFERENCE TO RELATED APPLICATIONS

This application claims priority to U.S. Appl. No. 62/379,200, filed Aug. 24, 2016 and titled “SYSTEMS AND METHODS FOR DYNAMIC, ATTRIBUTE BASED PRICE SETTING FOR DELIVERY AND FULFILLMENT FEES FOR ONLINE AND OFFLINE ORDERS,” the entire contents and disclosure of which is hereby incorporated by reference.

The present application is related to U.S. Provisional Application No. 62/171,831 filed Jun. 5, 2015, titled “SYSTEMS AND METHODS FOR SELF-CHECKOUT MERCHANDISE PURCHASING” and U.S. Non-Provisional application Ser. No. 15/172,086 filed Jun. 2, 2016, titled “SYSTEMS AND METHODS FOR. SELF-CHECKOUT MERCHANDISE PURCHASING”, which are hereby incorporated by reference in their entirety.

### FIELD

The subject matter described herein relates generally to systems and methods for dynamic, attribute based price setting for delivery and fulfillment fees for online and offline orders placed by consumers.

### BACKGROUND

In an increasingly globalized economy, merchants are engaged in commerce in larger geographic zones. This has resulted in merchants having to compete with a greater number of competitors. In an effort to build and maintain a reliable customer base, merchants have developed systems to try to build customer loyalty. Many of these systems involve providing incentives to new customers and benefits to repeat customers. These systems can help merchants attract new customers while minimizing the probability that current customers will leave for competitors. While many of these systems exist, they frequently involve providing discounts related to service charges including shipping, mailing and other related order fulfillment expenses. While some of these systems include one level, even those with multiple levels provide discounts that are generically provided to all customers of a particular level, regardless of their value to a business.

Currently, most merchant service charges are static, “flat” or otherwise standardized. In other words, most merchant service charges are non-customized and non-customizable on an individual customer basis. Non-customized service charges that are standardized for all customers fail to properly account for the differing value that each customer provides to the merchant in the form of repeat business, frequency of customer orders, profit margin per order, order size, customer acquisition cost and others. Due to this standardized non-customization, service charge benefits may not adequately incentivize customers to purchase from the merchant. As a result, the merchant may lose a potential repeat customer to a competitor. Alternatively, non-customization may provide unnecessary incentives for customers who would already be willing to order from the merchant again as a repeat customer. As such, the merchant may lose capital they would be able to apply more effectively elsewhere in their business. Aside from these two examples, other scenarios exist as well.

Thus, needs exist for improved techniques by which an individual merchant can incentivize new and repeat customers while minimizing wasted capital.

Other issues related to customer satisfaction are also important for merchants to address and solve in order to maximize the chance for repeat business. One such issue is the amount of time and effort that customers spend searching for suppliers and particular goods (“Searching”). The process of Searching is often inefficient because customers must sort and analyze suppliers, products, and search terms. One solution is to provide new systems and methods that allow customers to solicit offers from suppliers when a particular customer has identified a product, without the need for extended Searching.

### SUMMARY

Provided herein are embodiments of systems and methods for dynamically setting and adjusting a fee structure for individual customers of a particular business. This dynamic setting and adjusting can be manually or automatically adjusted based on various metrics. Examples of these can be individually applied to customers and can include historic, current and anticipated order frequency, average order size, average order cost, gross profit margin contribution as a percentage and dollar value per order, acquisition cost, physical delivery address, proximity to other customers and other factors.

In some embodiments, the solutions described herein can be used in conjunction with or in addition to other subscription or membership programs that have been developed previously or are developed in the future. In some embodiments, the systems and methods described herein can also be applied to set single order costs and offers where no membership program is offered. In some embodiments, they can be promotion based, time based, location based or based on other factors.

Also provided herein are systems and methods that allow customers to solicit offers from suppliers when a particular customer has identified a product, without the need for extended Searching.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an example embodiment of a basic network architecture diagram.

FIG. 1B is an example embodiment of a network connected server architecture diagram.

FIG. 1C is an example embodiment of a user mobile device diagram.

FIG. 2A is an example embodiment of a system operation flowchart.

FIG. 2B is an example embodiment of a system operation flowchart.

FIG. 2C is an example embodiment of a system operation flowchart.

FIG. 3 is an example embodiment of a user interface customer offer screen.

FIG. 4 is an example embodiment of a user interface customer offer screen.

FIG. 5 is an example embodiment of a user interface customer offer screen.

FIG. 6 is an example embodiment of a process flow chart.

FIG. 7 is an example embodiment of a user interface home screen.

FIG. 8 is an example embodiment of a user interface login screen.

FIG. 9 is an example embodiment of a user interface account creation screen.

FIG. 10 is an example embodiment of a user interface user agreement screen.

FIG. 11 is an example embodiment of a user interface account creation information screen.

FIG. 12 is an example embodiment of a user interface introduction screen.

FIG. 13 is an example embodiment of a user interface payment selection screen.

FIG. 14 is an example embodiment of a user interface payment source entry screen.

FIG. 15 is an example embodiment of a user interface CVV confirmation screen.

FIG. 16 is an example embodiment of a user interface product image capture screen.

FIG. 17 is an example embodiment of a user interface captured image selection screen.

FIG. 18 is an example embodiment of a user interface captured image selection screen.

FIG. 19 is an example embodiment of a user interface review current order screen.

FIG. 20 is an example embodiment of a user interface review offer review screen.

FIG. 21 is an example embodiment of a user interface review offer review screen.

FIG. 22 is an example embodiment of a user interface review offer comparison screen.

FIG. 23 is an example embodiment of a user interface review current order totaling screen.

FIG. 24 is an example embodiment of a user interface current order summary screen.

FIG. 25 is an example embodiment of a user interface current order processing screen.

FIG. 26 is an example embodiment of a user interface current order complete confirmation notification screen.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims. As such, the configuration of systems, methods and devices herein are described in terms of various embodiments which are only examples.

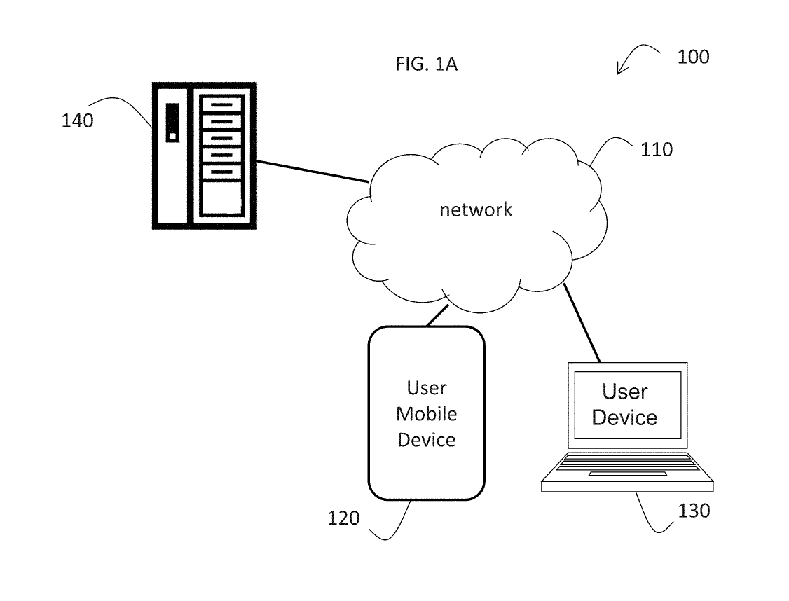

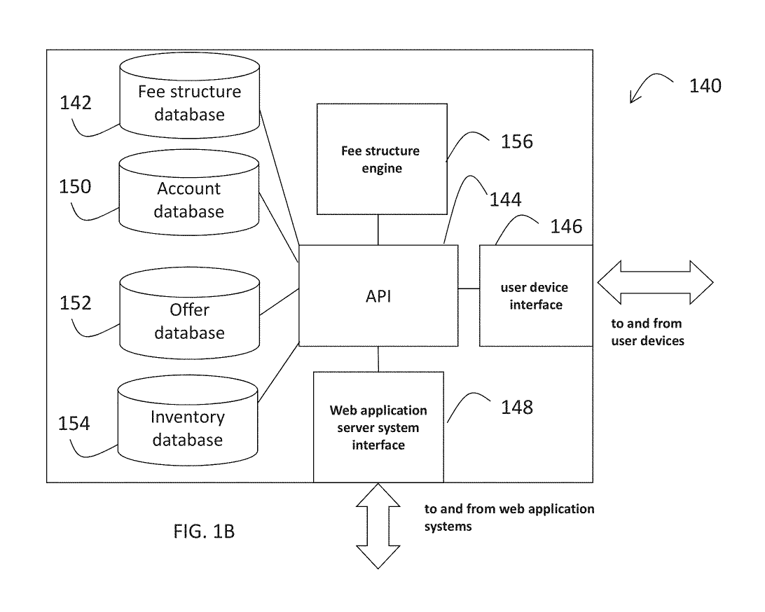

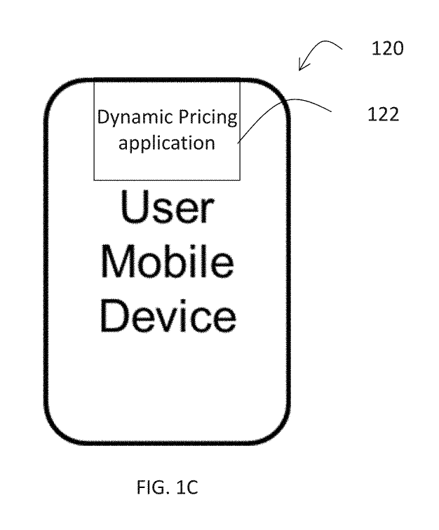

FIG. 1A is an example embodiment of a basic network architecture diagram 100. As shown in the example embodiment, network setup diagram 100 of can include one or more servers 140 which can include applications distributed on one or more physical servers, each having one or more processors, memory banks, operating systems, input/output interfaces, power supplies, network interfaces, and other components and modules implemented in hardware, software, or combinations thereof as are known in the art. These servers can be communicatively coupled with a wired, wireless or combined network 110 such as a public network (e.g. the Internet, cellular-based wireless network or other public network), a private network or combinations thereof as are understood in the art. Server 140 can be operable to interface with websites, webpages, web applications, social media platforms, advertising platforms, and others. As shown, a plurality of user devices 120, 130 can also be coupled to the network and can include, for example: user mobile devices such as smart phones, tablets, phablets, handheld video game consoles, media players, laptops; wearable devices such as smartwatches, smart bracelets, smart glasses or others; and other user devices such as desktop devices, fixed location computing devices, video game consoles or other devices with computing capability and network interfaces and operable to communicatively couple with network 110.

Although not specifically shown, various other or additional mobile applications, mobile devices such as smart phones/tablets, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers, power components and other equipment and devices as appropriate to implement the methods and systems described herein are contemplated.

FIG. 1B is an example embodiment of a network connected server architecture diagram 140. a network connected server system diagram 140. As shown in the example embodiment, a server system can include at least one user device interface 146 and at least one web application server system interface 148 implemented with technology known in the art for facilitating communication between customer and system user devices respectively and the server and communicatively coupled with a server-based application program interface (API) 144. As such, API 144 can provide the web application server system interface 148 communication with web applications, websites, webpages, websites, social media platforms, and others. API 144 can also be communicatively coupled with a server based fee structure database 142, account database 150, offer database 152, and inventory database 154 combinations thereof or other databases and other interfaces. API 144 can instruct databases 142, 150, 152, 154 to store (and retrieve from the databases) information such as fee structures, product information, user account information, associated account information, offer information, inventory information and others as appropriate. Examples of other databases can include historical purchasing databases that track customer orders, supplier related databases, and others. Databases 142, 150, 152, 154 can be implemented with technology known in the art, such as relational databases, object oriented databases, combinations thereof or others. Databases 142, 150, 152, 154 can be a distributed database and individual modules or types of data in the database can be separated virtually or physically in various embodiments.

Also included is a fee structure engine 156, coupled to API 144, which can be implemented in hardware, software, or a combination of both and can include processors, instructions stored in non-transitory computer readable memory and other components and structures. Fee structure engine 156 can be used to review, update, cancel, modify, or otherwise process fee structure related data. As such, fee structure engine can synthesize data stored in server memory or accessible via the network, in order to perform calculations related to how particular fees and their application are processed. This can be executed by one or more processors performing steps stored in non-transitory memory of the system. As an example, when calculating a fee for a particular customer, an algorithm might account for past purchasing history, loyalty, frequency of transacting, geographical location, price fluctuations, and other valuable information that can be used in various formulas to calculate how a fee should be applied or what to charge or offer a particular customer for an order.

FIG. 1C is an example embodiment of a user mobile device diagram. As shown in the example embodiment, a user mobile device 120 can include a network connected dynamic pricing application 122 that is installed in, pushed to, or downloaded to the user mobile device. In many embodiments user devices are touch screen devices such as smart phones, phablets or tablets which have at least one processor, network interface, camera, power source, memory, speaker, microphone, input/output interfaces, operating systems and other typical components and functionality. In some embodiments, special devices can be provided in retail establishments. These may include some or all of these components, as required to provide the functionality described herein. These fee structures can be automatically, semi-automatically, and manually changed by system administrators as well.

In the various systems, devices, and methods contemplated and briefly described in the summary herein, various factors can be weighted and used in conjunction with one another or alone in order to set a particular fee value for an individual customer. Examples of factors that can be used include: (i) delivery fee as a cost to the business; (ii) minimum order size, number of items, weight or cost required; (iii) program or membership fee cost to the customer in a subscription scenario; (iv) program or membership period length of time in a subscription scenario; (v) number of permitted deliveries over a particular time period in a subscription scenario; and (vi) others. In some embodiments, the systems and methods described herein can also be applied to set single use costs and offers where no membership program is offered.

Defining a delivery fee, service fee, shipping & handling fee or other fee, referred to collectively herein as a “fee” or “fees”, can be value based and set on a per user basis or users can be grouped into different value categories. These definitions can be based on pre-defined and tunable criteria and thresholds that are stored in non-transitory computer readable memory for use in calculating order and offer prices. Thus, these customized definitions can allow businesses to define fee offers based on a particular value of an offer and can be customer specific. In some embodiments, a lifetime customer value, as defined by the particular business can be determined or set based on one or more of a particular customer's prior order history, current orders and anticipated orders. This value can be used to provide benefits for repeat customers or other price adjustments.

In various embodiments, customer value can be calculated based on or otherwise related to a number of factors. These can include a customer's historical, current and anticipated order frequency, profit margin contribution to the business, order size, acquisition cost, cost to service and others, all of which can be stored in computer readable memory in one or more databases. In some embodiments, geographical or physical proximity to other customers and an order fulfillment center for a particular business can be a relevant and important indicator in helping to determine a customer's value because a customer that is cheaper for the business to serve because of their proximity to other customers or the fulfillment center. As such, this customer may be more valuable to the business from a profitability standpoint than a more physically isolated customer who may be more expensive to serve. Further, data relating to geographical location and purchasing history can be used by these businesses to affect offers and order prices.

In an example embodiment, a business “B” may have a first frequent customer “C1” who may receive an offer with a value “V1”. Similarly, business “B” may have a second infrequent customer “C2” who may receive an offer with a value “V2”. V1 may be less valuable than V2 in the example embodiment because, since C1 is a frequent customer, C1 may not require as much incentive to purchase from business B. Conversely, since customer C2 is an infrequent customer, providing them with a higher value V2 may entice or encourage C2 to purchase from business B more often, since they are being provided with an improved incentive to order. As an example, if the offer is related to or influenced by shipping costs, value V2 could be free shipping from business B, while value V1 may only be a slightly reduced shipping offer, as compared with standard shipping rates.

In another example embodiment, the logic provided in the prior example embodiment can be reversed. As such, the loyalty provided by frequent customer C1 to business B can be rewarded in the form offer value V1 being better than that of value V2. As such, for the offer related to shipping costs, value V1 could be free shipping from business B, while value V2 may only be a slightly reduced shipping offer, as compared with standard shipping rates.

In some embodiments, customers can be notified of their status as frequent or infrequent customers, or at intermittent levels therebetween. In some embodiments where customers are notified of their status or level, they can also be informed of how to best improve their level, such that they may receive improved offers with better values.

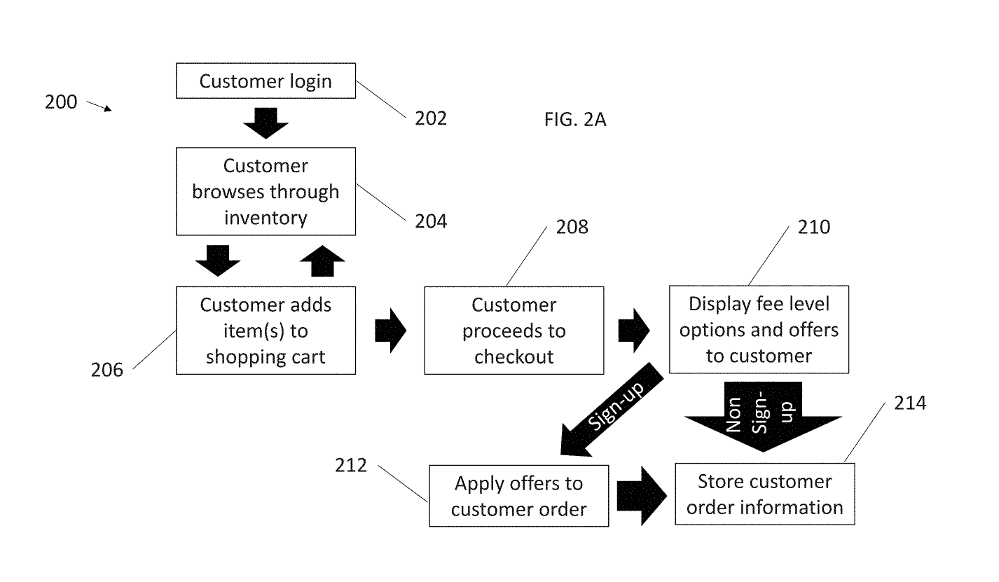

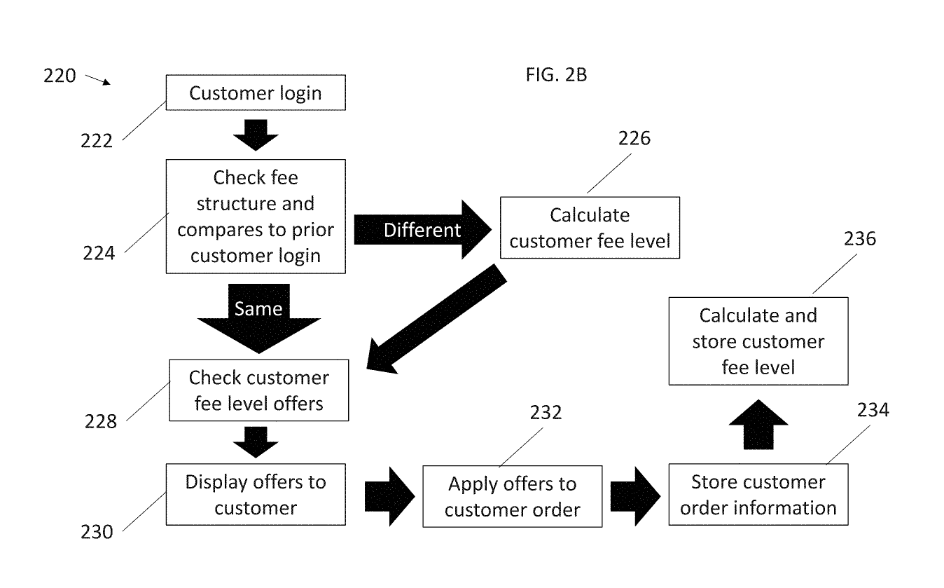

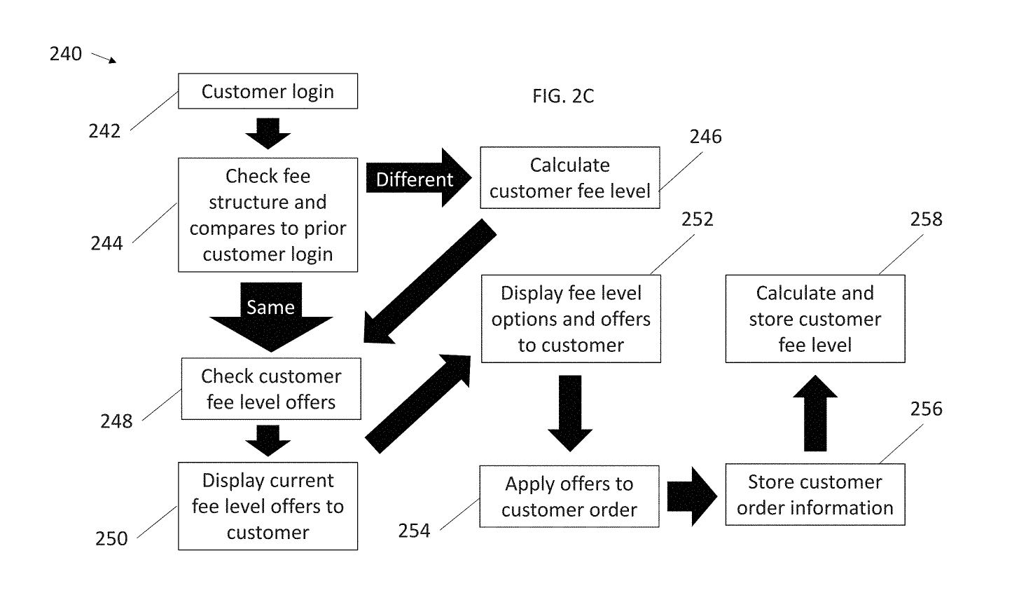

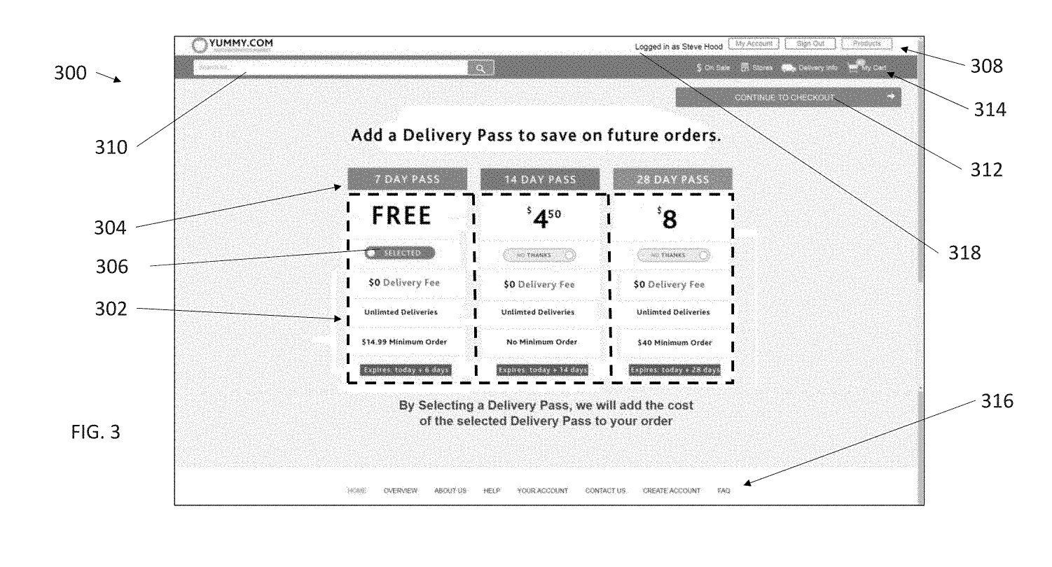

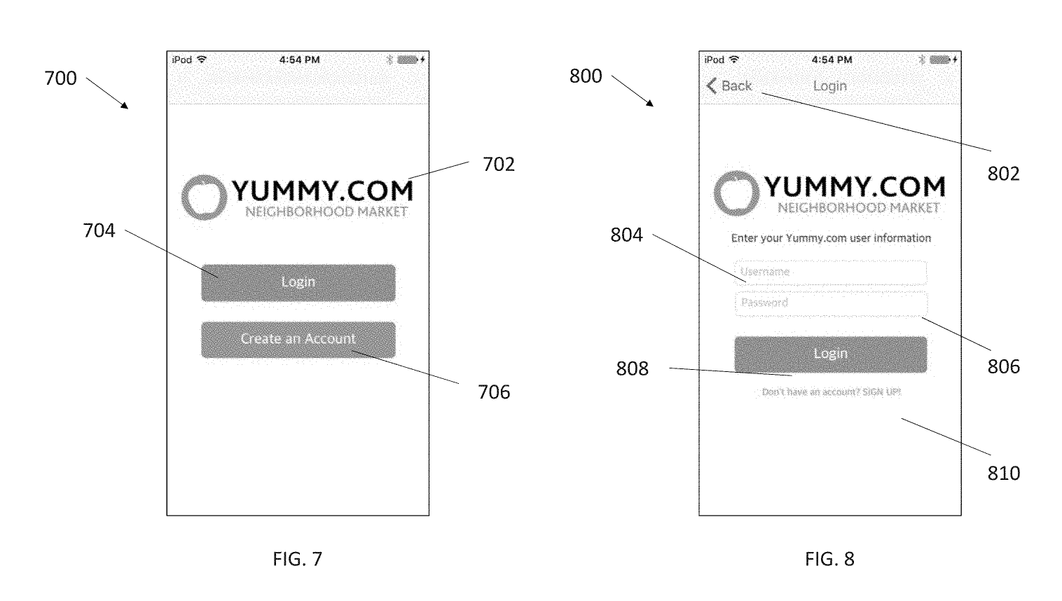

FIG. 2A is an example embodiment of a system operation flowchart 200. As shown in the example embodiment, at a first step 202 a customer can log in to the system using a user interface of a user device or user mobile device (e.g. see FIG. 7). Once logged in, the user can perform shopping functions in a virtual store by browsing through inventory is a second step 204 and adding items to a shopping cart in a third step 206. The user can repeat steps 204 and 206 until they have all the items desired for the current transaction. Once the customer is ready to check out, in a fourth step 208 they can be shown a fee level option user interface screen in a step 210 where they can be shown offers, requirements, or other information related to one or more fee levels (e.g. see FIGS. 3-5). The user can add or remove items from their cart to remain at or move down a fee level, or elect to sign-up for a particular fee level. If they elect or otherwise qualify for a particular fee level, one or more offers or other promotions associated with that fee level can be applied to their order in step 212 and the checkout operation can then be completed by storing customer order information in one or more non-transitory databases in computer memory in step 214 before completing a standard checkout operation. Otherwise, if the user elects not to sign up in step 210, the system can store the customer order information in step 214 and then proceed through the normal checkout operation.

FIG. 2B is an example embodiment of a system operation flowchart 220. As shown in the example embodiment, a customer can first log into the system using a user interface of a user device or user mobile device in a first step 222. Once logged in, the system can check the current fee structure being applied and compare it with a fee structure from when the customer last logged in during step 224. If the fee structures are different, the system can calculate a new customer fee level based on the new structure in step 226 and the system can then check customer fee level offers in step 228. Otherwise, if the structures are the same in step 224, the system can check customer fee level offers in step 228. Offers can then be displayed to the customer in step 230 (e.g. see FIGS. 3-5), applied to a customer order in step 232, and customer order information can be stored in non-transitory computer readable memory during or prior to checkout operations in step 234. Then, in step 236, a current customer fee level can be calculated and updated for the current customer's user account information before being stored in non-transitory computer readable memory in step 236 for use the next time the customer logs in, for example in a step 224 in subsequent transaction processes.

FIG. 2C is an example embodiment of a system operation flowchart 240. As shown in the example embodiment, a customer can first log in to the system using a user interface of a user device or user mobile device in step 242. Once logged in, the system can check the current fee structure being applied and compare it with a fee structure from when the customer last logged in during step 244. If the fee structures are different, the system can calculate a new customer fee level based on the new structure in step 246 and the system can proceed to check customer fee level offers in step 250. Otherwise, if the structures are the same in step 244, the system can check customer fee level offers in step 248. The system can then display current fee level offers to the customer in step 250 (e.g. see FIGS. 3-5) before displaying fee level options and their associated offers to the customer in step 252. The customer is then free to make a fee level selection or not and any offers can be applied to a customer order based on the fee level in step 254. Next, customer order information can be stored in non-transitory computer readable memory during or after a checkout operation in step 256. Subsequently, a current customer fee level can be calculated and updated in step 258 before being stored in non-transitory computer-readable memory for reference during later customer transactions, for example in a step 244 of a later transaction.

FIG. 3 is an example embodiment diagram 300 of a user interface customer offer screen. As shown in details area 302, various offer details can be displayed that are associated with a variety of fee levels 304. Here each fee level is based on a different “Delivery Pass.” One includes a time based 7-day pass that is free and is indicated as having been selected by a user via an interactive user interface button 306. Another is a 14 day pass that costs $4.50 and is indicated at not selected but could be by selecting an associated button that is similar to 306. Another is a 28 day pass that costs $8 and is indicated at not selected but could be by selecting an associated button that is similar to 306. As shown in offer details area 302, each of the offers includes a $0 delivery service fee and provides unlimited deliveries. The free option requires $14.99 minimum orders. The $4.50 option has no minimum order price requirements. The $8 option requires $40 minimum orders. Time limits are also displayed for user convenience, here described as an expiration date with additional days to claim each offer.

As shown in example embodiment diagram 300, a customer offer screen can include account, sign out, and product listing buttons 308. Customers can also search for items by entering item or product information into a search field 310. As shown in the example embodiment, this screen can be shown to users prior to checkout operation and after a user has logged in and selected one or more items for purchasing. If the user does not wish to choose a fee level or has selected one as shown by indicator 306, customers can select a “Proceed to Checkout” button 312. Users can also select buttons 314 that will show them on sale items, store locations, delivery information, listings of items in their cart currently and others. Further, users can select various buttons 316 to view information such as a home, overview, about us, help, your account, contact us, create account, FAQ, and others, as appropriate. If a user is logged into an account in the system, their account name can be displayed in field 318.

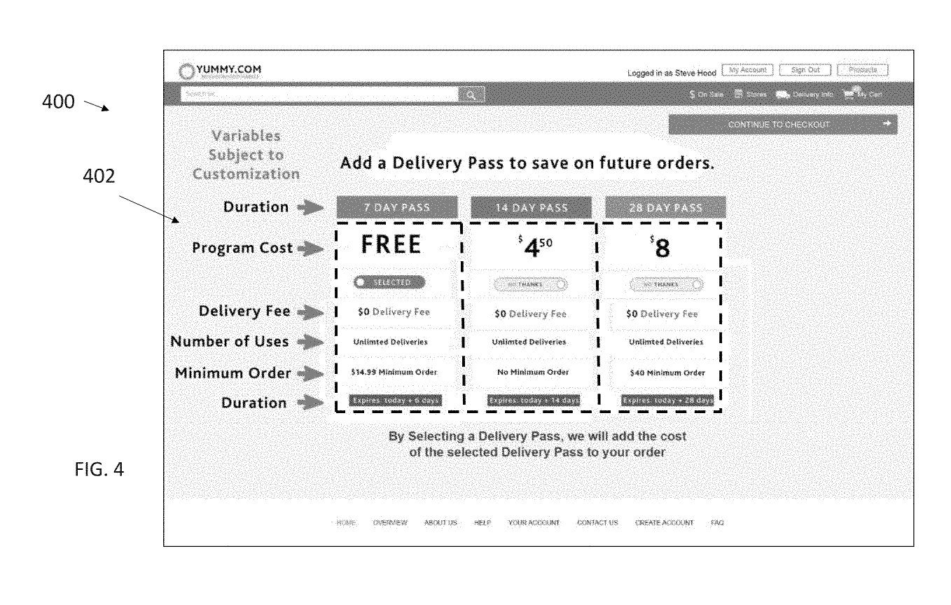

FIG. 4 is an example embodiment of a user interface customer offer screen 400. As shown in the example embodiment, various factors 402 are subject to customization. These can include duration of the passes, program costs, delivery fees, number of uses and minimum order prices. Various others are contemplated as well including, but not limited to, minimum order weight.

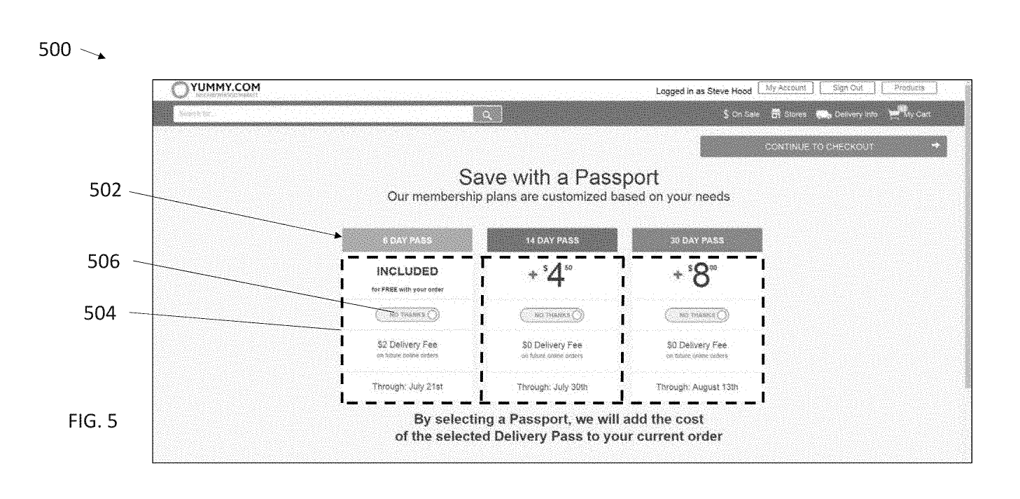

FIG. 5 is an example embodiment of a user interface customer offer screen 500. Offers shown in the example embodiment include a variety of fee levels 502, here each is called “Passport”. Each passport has information displayed relating to the features in details area 504. One passport includes a time based 6-day pass that is free and is indicated as not selected but could be by selecting an associated button 506. Another passport is a 14 day pass that costs $4.50 and is indicated at not selected but could be by selecting an associated button. Another is a 30 day pass that costs $8 and is indicated at not selected but could be by selecting an associated button. The first provides a $2 delivery fee on future online orders while each of the latter options includes a $0 delivery service fee on future online orders. The free option requires is indicated as providing orders through July 21st. The $4.50 option is indicated as providing orders through July 30th. The $8 option is indicated as providing orders through August 13th. Selecting a passport can automatically add the cost of the passport to a final order total.

Since users spend time and effort searching for required goods and suppliers (“Searching”), this process can be inefficient when a user must sort and analyze suppliers, products and terms. A more direct method is included wherein a user is able to solicit offers for supply when the product is identified without a need for Searching. As such, systems and methods included provide users the benefit of soliciting offers from suppliers when the customer has identified a particular product.

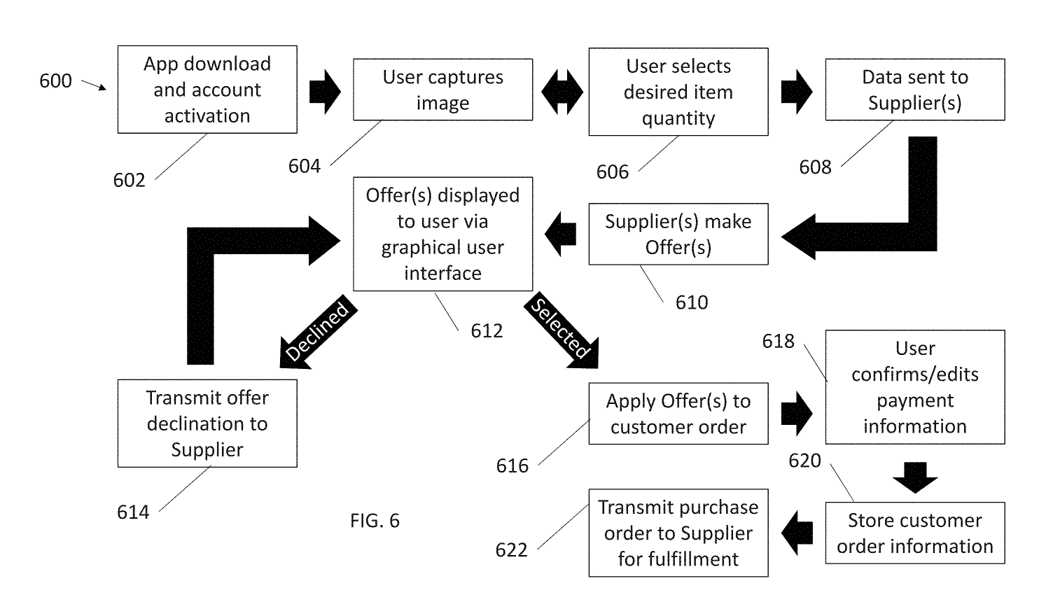

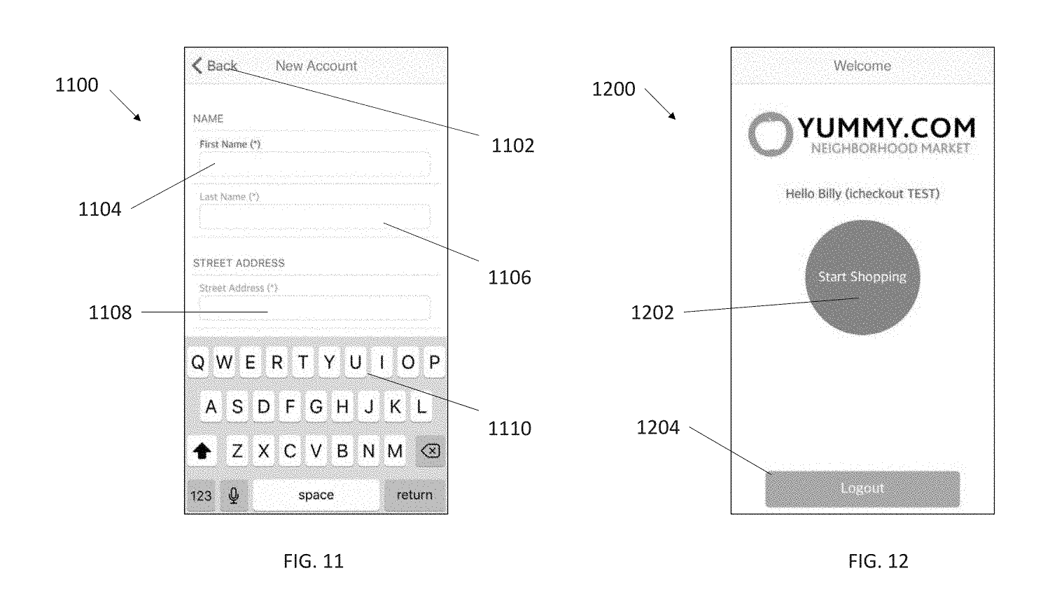

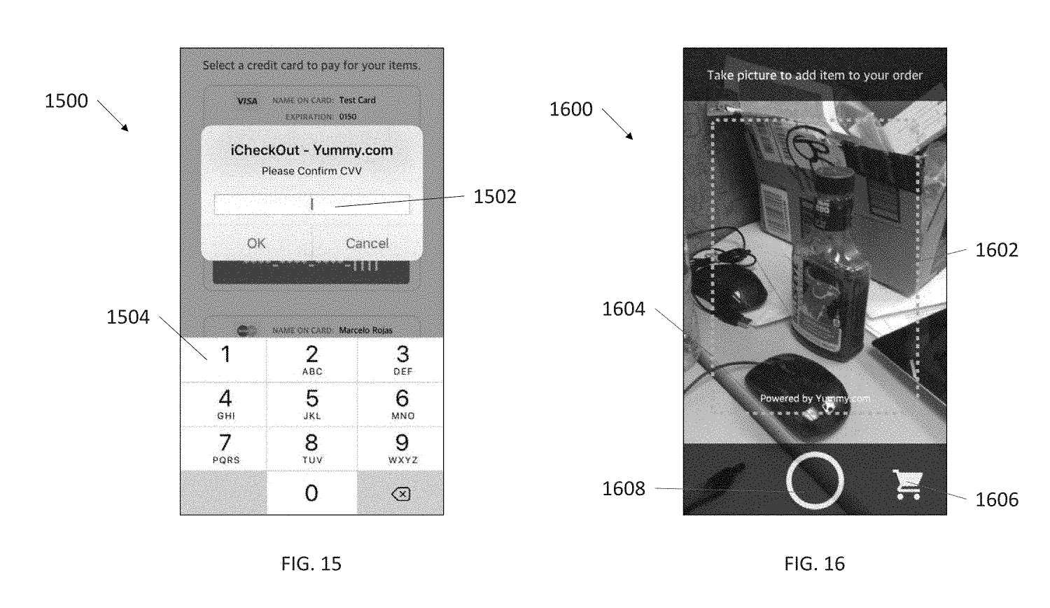

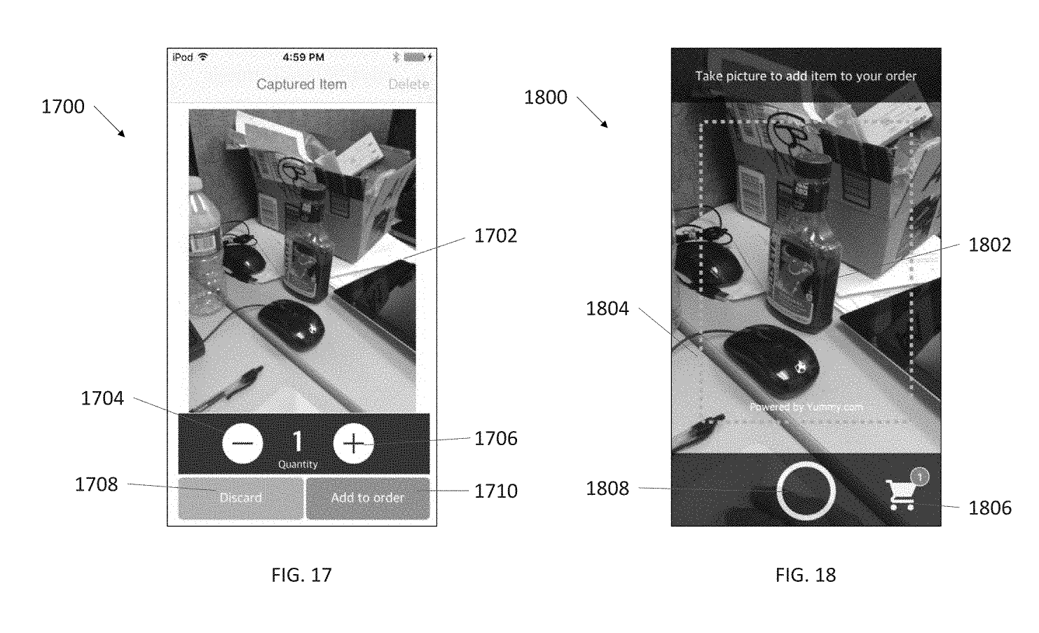

FIG. 6 shows an example embodiment of a process flowchart 600. As shown in the example embodiment, a customer user can first download an application to a smartphone, tablet, laptop or another user device in step 602 (e.g. see FIG. 7). The user can then sign-up for an account (e.g. see FIG. 11), customize personal settings and preferences and provide or select one or more payment methods (e.g. see FIG. 15). In some embodiments, users need not download an application but instead can sign-up and sign-in to a website or web portal via a web browser on a user device that is communicatively coupled with a network. Next, a user can capture an image of a product or item, scan a UPC, enter a product name using a user interface or otherwise provide product identification information (“Product Information”) in step 604 (e.g. see FIG. 16). The application can automatically search through one or more item databases or, in some embodiments, perform automatic Internet searches via a computer network. If the product is found, the system can provide a product listing with the product name, features, price, and other relevant information. In some instances, related, complementary, or competing products can also be displayed nearby the product that was found via a graphical user interface. Next, the user can select or confirm a product identity and select or enter a quantity of the confirmed products that they desire in step 606 (e.g. see FIG. 17). In some embodiments, multiple items can be selected together to create an order. Steps 604 and 606 can be repeated as necessary until a user has determined that they have all products that they wish to purchase for the order.

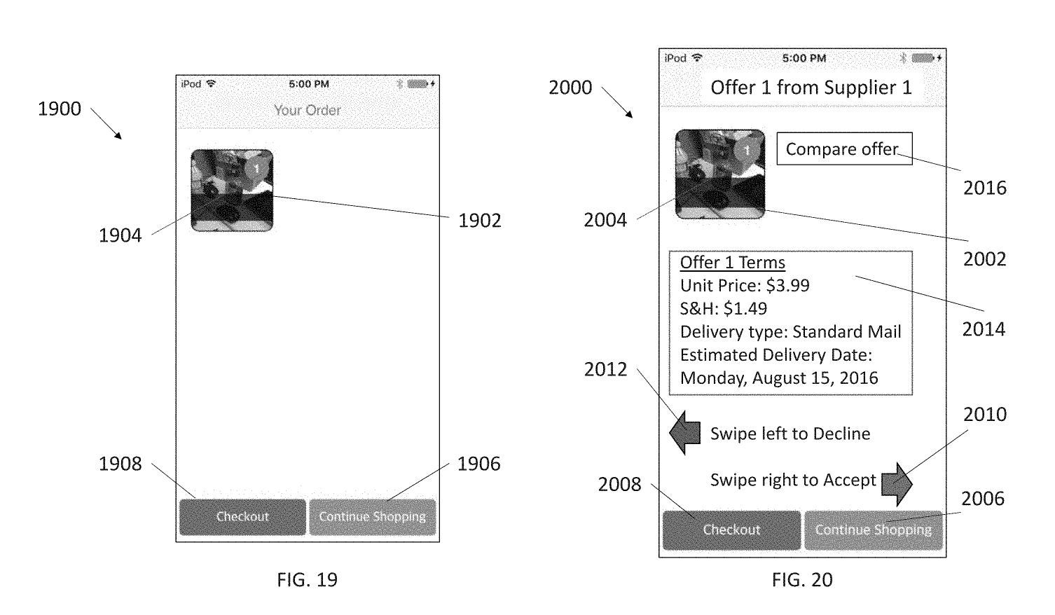

Once the user has reviewed the order (e.g. see FIG. 19) indicates that they have finalized their order, for example by selecting a checkout button displayed on a graphical user interface, product and quantity information can be transmitted from the system server or customer device via the network to one or more suppliers, vendors, or marketplaces (“Suppliers”) in step 608. This information can be used to solicit or otherwise procure offers (“User Offers”) related to the product or products from the Suppliers. Product information can include SKU, UPC, names, or other identifying information. This transmission of product information can be performed for each product individually or as part of an order. Once received via the network, the solicitation or procurement User Offer can be displayed for manual review by the Suppliers on a graphical user interface of a user device. Alternately, it can be automatically checked against a Supplier database for acceptance and delivery. The Supplier can manually, automatically, or semi-automatically create or select one or more User Offers to fulfill. If a User Offer is selected, the Supplier can prepare a “Supplier Offer” in step 610 with terms of sale for one or more products in the User Offer for the customer user. In some instances, this can include defining or otherwise setting various criteria. These defined criteria can include and are not limited to: unit price per item, quantity, shipping cost, shipping time, pickup location, discounts, loyalty program information, competing or related product information, cost, and various others. Once created or selected, data information for the Supplier Offer can be transmitted from the Supplier to the customer user device via the network for user review in the application or web browser or portal.

Once received, one or more Supplier Offers from one or more Suppliers can be presented via the user interface to the user in step 612 based on one or more logical or random data structures (e.g. see FIGS. 20-22). These can be preset or individually defined based on user preferences, system settings, or other criteria. Some logical data presentation structures individually include and are not limited to: lowest-to-highest unit cost, highest-to-lowest unit cost, lowest-to-highest shipping cost, highest-to-lowest shipping cost, fastest-to-slowest shipping time, slowest-to-fastest shipping time, best-to-worst discount, worst-to-best discount and others. In some embodiments combinations of one or more structures can also be used.

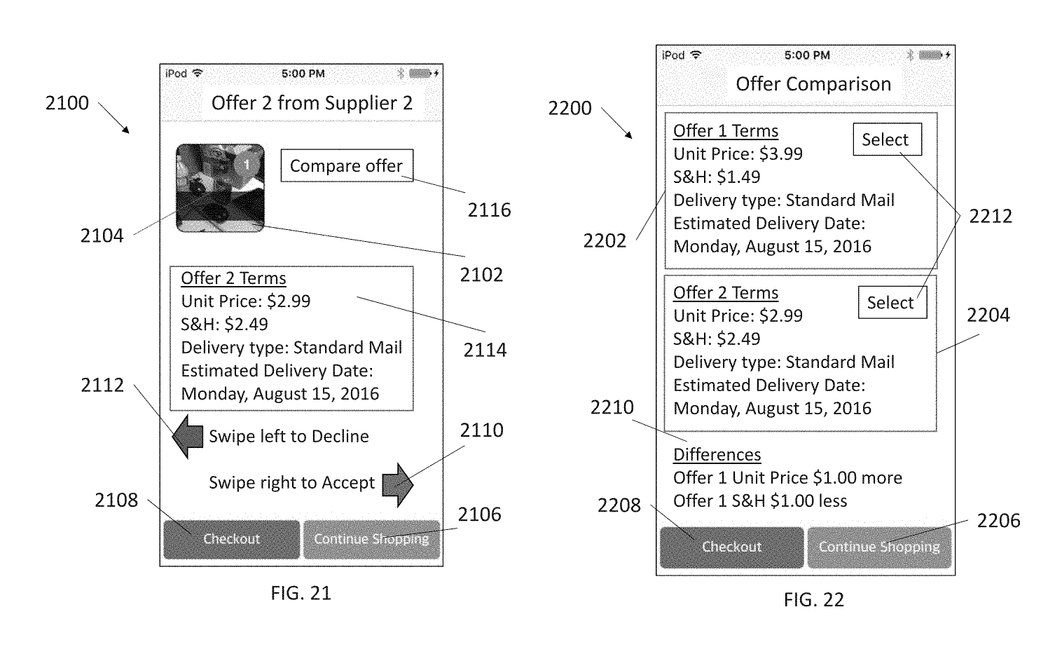

In some embodiments, Supplier Offers can be presented to the user in the application in a single Supplier Offer per screen format, in other words, one Supplier Offer at a time (e.g. see FIGS. 20-21). The user is presented with the opportunity to accept or reject the offer by selecting an appropriate option via the user interface. When the application is run on a smartphone with a touchscreen device, this can include “swiping” left to reject the Supplier Offer or “swiping” right to accept the Supplier Offer. In some embodiments users can create, select, or otherwise make a “Counter-Offer” for review by the Supplier with one or more modifications of the Supplier Offer's terms. If the user declines a Supplier Offer, this information can be tracked and stored by the system in non-transitory computer readable memory in a database. Additionally, information regarding the declined Supplier Offer can be transmitted to the Supplier for review via the network in step 614 before another Supplier Offer is shown to the customer user in step 612. This can help Suppliers to create better Supplier Offers in the future. Additionally, in some embodiments when a user has declined a Supplier Offer and ultimately selects another Supplier's Offer, the terms of the selected Supplier Offer can be sent to the Supplier whose Supplier Offer was rejected. This can encourage competition among Suppliers and provide enhanced benefits for customers.

In some embodiments, multiple Offers can be presented in a single screen so that the User can compare their terms against each other (e.g. see FIG. 22). Users can then view and select their preferred Offer from the multiple Offers. Terms of the order can be displayed (e.g. see FIG. 24) and any selected offer information can be applied as well.

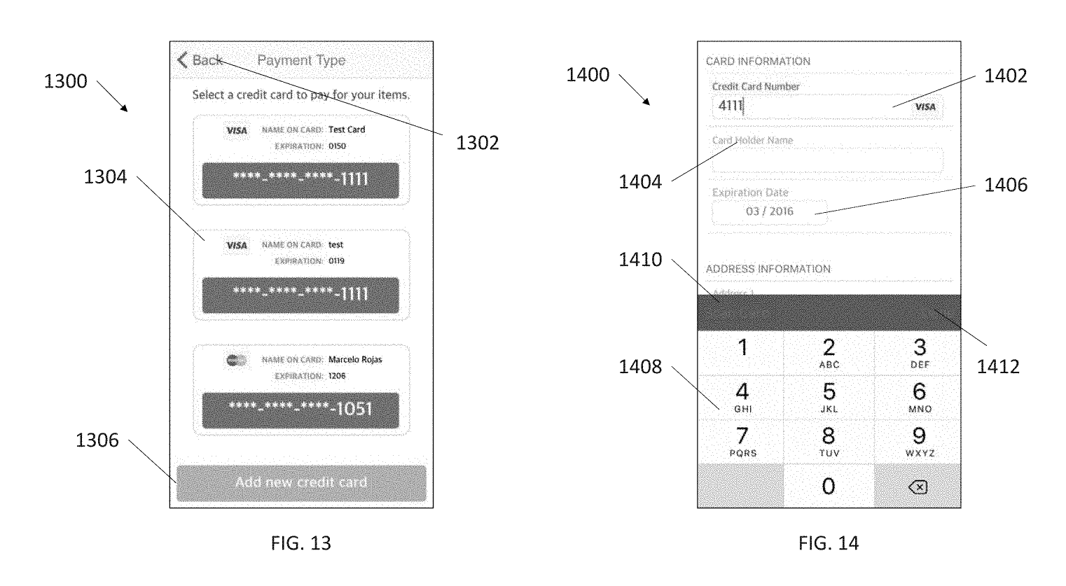

Once an Offer has been selected and accepted by the user, the system can apply the Supplier Offer to the customer's order in step 616. Next, the user can enter, edit, select, or confirm a previously selected payment method or source in the application in step 618 (e.g. see FIGS. 13-15). Then the order information, including the selected Supplier Offer, can be stored for later review by the user, system administrators, or Supplier representatives in step 620. The system can then automatically, manually, or semi-automatically create and transmit a Purchase Order that is issued to the Supplier for fulfillment via the network in step 622.

FIGS. 7-26 show example embodiments of user interfaces that can be displayed when users are interacting with the system.

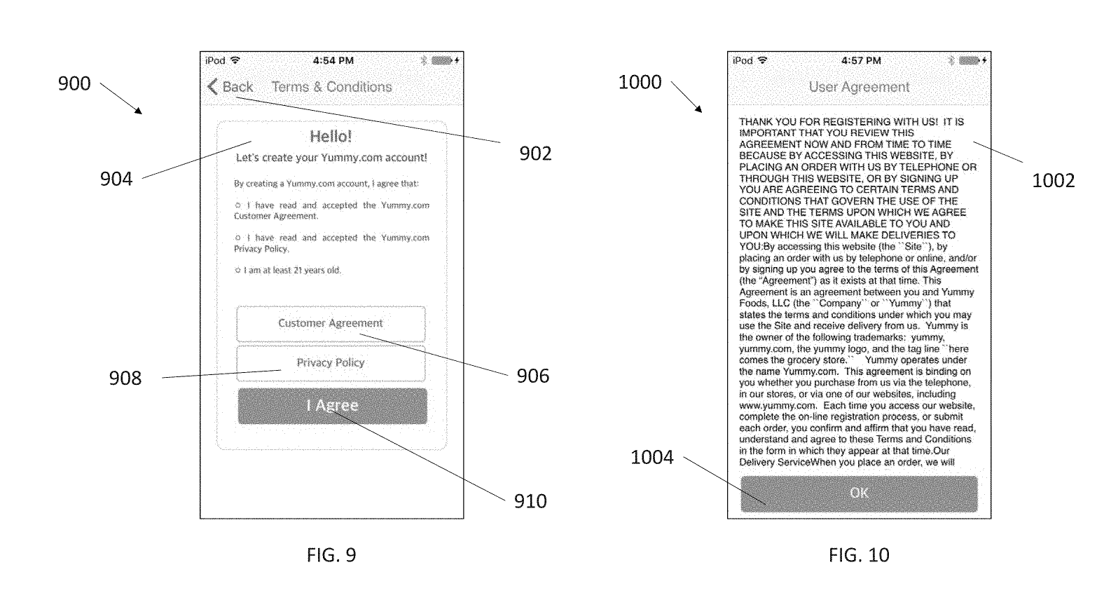

FIG. 7 is an example embodiment of a user interface home screen 700. As shown in the example embodiment, a user can view an application name field 702 showing the name of the application. In the example embodiment, this is “YUMMY.COM NEIGHBORHOOD MARKET.” A user can select a “Login” button 704 if they already have an account (see FIG. 8 and associated description) or a “Create an Account” button 706 if they do not have an account but wish to create one (see FIG. 9 and associated description).

FIG. 8 is an example embodiment of a user interface login screen 800. As shown in the example embodiment, a user can navigate to a previous screen by selecting a “Back” button 802. Otherwise, a user can enter a system username in a “Username” field 804 and a system password in a “Password” field 806 before selecting a “Login” button 808 that will check the entered credentials with system records stored in a database or other structure in non-transitory memory before accepting or denying the user access to the system. If the user does not have an account, they can create one by selecting a “SIGN UP!” button. This can take them to a user account creation screen, as shown in FIG. 9.

FIG. 9 is an example embodiment of a user interface account creation screen 900. As shown in the example embodiment, a user can navigate to a previous screen by selecting a “Back” button 902. Terms and Conditions of account creation can be described in an instruction field 904. In the example embodiment, these read: “Hello! Let's create your Yummy.com account! By creating a Yummy.com account, I agree that: I have read and accepted the Yummy.com Customer agreement. I have read and accepted the Yummy.com Privacy Policy. I am at least 21 years old.” A user can review a customer agreement by selecting a “Customer Agreement” button 906 that can take them to a user or customer agreement screen, as shown in FIG. 10. The user can review a privacy policy by selecting a “Privacy Policy” button 908 which will display this respective privacy policy information. A user can then select an “I Agree” button 910 to move forward to a user interface account creation information screen, as shown in FIG. 11.

FIG. 10 is an example embodiment of a user interface user agreement screen 1000. As shown in the example embodiment, a user can review a customer or user agreement which can be displayed in a scrollable field 1002. If the user agrees, they can select an “OK” button 1004 that can take them back to an account creation screen, as shown in FIG. 9. In some embodiments, a disagree button (not shown) may be provided in the Terms and Conditions screen or User Agreement screen.

FIG. 11 is an example embodiment of a user interface account creation information screen 1100. As shown in the example embodiment, a user can navigate to a previous screen by selecting a “Back” button 1102. Users can enter personal information when creating an account such as a first name in first name field 1104, a last name in last name field 1106, an address in address field 1108 and others such as email address, phone numbers, or other information in appropriate fields using a keypad 1110. Once the information is entered the user may select a proceed button (not shown) and the user interface will then display an introduction screen, as shown in FIG. 12.

FIG. 12 is an example embodiment of a user interface introduction screen 1200. As shown in the example embodiment, the user can begin a shopping experience by selecting a “Start Shopping” button 1202 (see FIG. 13 and associated description). A user can log out of the application using a “Logout” button 1204. In some embodiments, a tutorial or other information presentation can be selected that will walk the user through the basics of navigating the system.

FIG. 13 is an example embodiment of a user interface payment selection screen 1300. As shown in the example embodiment, a user can navigate to a previous screen by selecting a “Back” button 1302. A consumer or customer user can enter new payment information, such as credit or debit card information into appropriate fields displayed in the application by selecting an “Add new credit card” button 1306 (see FIG. 14 and associated description) and can view and select various saved payment information details in payment information selection fields 1304, in order to choose an appropriate payment method.

FIG. 14 is an example embodiment of a user interface payment source entry screen 1400. As shown in the example embodiment, add a credit card number in Credit Card Number field 1402, a name associated with the card in Card Holder Name field 1404, an expiration date in Expiration Date field 1406 and billing address in one or more address fields (not shown) manually using a keypad 1408. Users can also capture credit card information using a camera or other scanner of the user device by selecting a “Scan Card” button 1410, which will display a camera screen that the user can use to capture the information. Once complete, the user can select a “Done” button 1412, which will store the information locally in non-transitory computer readable memory and then cause the application to display a CVV confirmation screen, as shown and described with respect to FIG. 15.

FIG. 15 is an example embodiment of a user interface CVV confirmation screen 1500. As shown in the example embodiment, a user can confirm a credit card CVV number by entering it into a “Please Confirm CVV” field 1502 using a keypad 1504. This can help to ensure that the user is an authorized user of the payment method. Payment information can be checked locally with stored data in non-transitory memory of the user device or transmitted over a network to a system or third-party server with payment information stored in non-transitory memory for confirmation using an automated algorithm that is stored in non-transitory memory and executed by a processor. Once an authorized payment method has been confirmed by the user, they can begin shopping using the application, for instance by being directed to a product image capture screen as shown in FIG. 16.

FIG. 16 is an example embodiment of a user interface product image capture screen 1600. As shown in the example embodiment, a user can aim a camera of the user device at a product 1602 that they wish to purchase to ensure it is within a capture window 1604. Once the user decides to capture the image, they can select a capture image button 1608 and then be shown a captured image selection screen, as shown in FIG. 17. The user can also view a current cart by selecting cart button 1606, as shown in FIG. 19.

FIG. 17 is an example embodiment of a user interface captured image selection screen 1700. As shown in the example embodiment, a user can view the image of the product 1702 and increase or decrease a quantity of items using a subtract button 1704 or add button 1706. Users can also choose to discard the image and product from their order by selecting a discard button 1708. Additionally, users can confirm the quantity and product by selecting an add to order button 1710. Once added to the order, a user can be shown a current order screen, as shown in FIG. 19.

FIG. 18 is an example embodiment of a user interface captured image selection screen 1800. As shown in the example embodiment, a user can capture another product 1802 or the same product in window 1804 using capture button 1808. A cart with a number of current items is shown as selectable cart icon 1806, which can take the user to a current order screen as shown in FIG. 19.

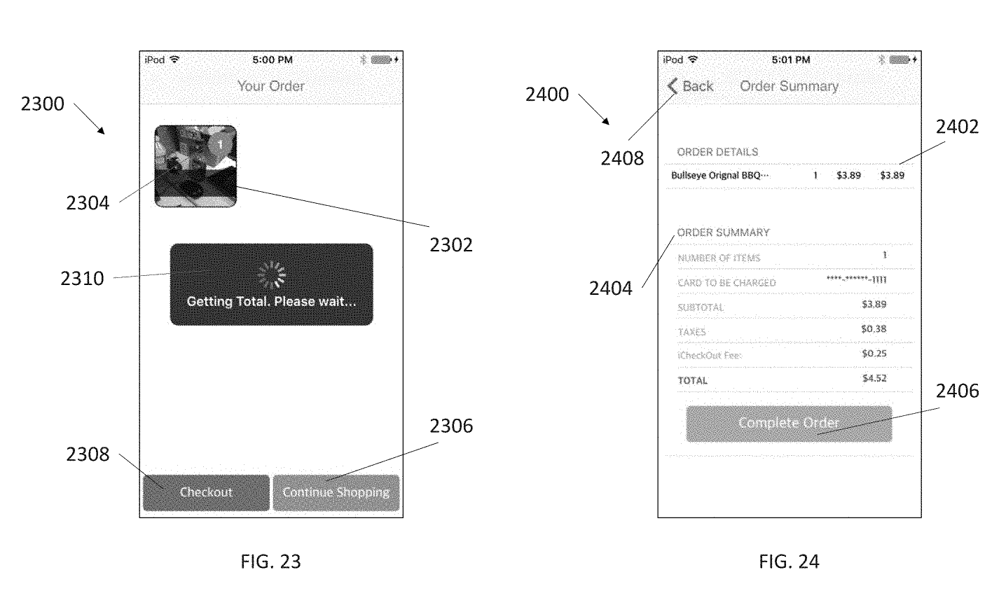

FIG. 19 is an example embodiment of a user interface review current order screen 1900. As shown in the example embodiment, a user can view images 1902 of products they have captured as well as quantities 1904 of the products they selected. They can choose to continue shopping by selecting a “Continue Shopping” button 1906 (see FIG. 18 and associated description) or choose to end the current session and purchase the products by selecting a “Checkout” button 1908 (see FIG. 23 and associated description). In some embodiments, users can begin creating an order in a remote location, such as their home, before completing the order by adding additional items to it in a retail store. These incomplete orders can be stored in non-transitory computer readable memory either locally or on a centralized server and recalled by the application for use in the future.

FIG. 20 is an example embodiment of a user interface offer screen 2000. As shown in the example embodiment, a user can view images 2002 of products included in the Supplier Offer, as well as quantities 2004 of the products they selected. Terms of a first supplier offer are shown in offer detail area 2014. Here, these include unit price, shipping and handling, delivery type, estimated delivery date, and others, as appropriate. A user can interact with the user interface in order to accept the offer or decline the offer. Here, this includes swiping toward 2012 to the left to decline an offer or swiping toward 2010 to accept the offer. In some embodiments, buttons can be provided at 2010 or 2012 that the user can interact with. The user can also select additional items by selecting a continue shopping button 2006 or go to a checkout screen by selecting a checkout button 2008. Further, a user can select a “compare offer” button 2016, in order to compare an offer with another offer.

FIG. 21 is an example embodiment of a user interface offer screen 2100. As shown in the example embodiment, a user can view images 2102 of products included in the Supplier Offer, as well as quantities 2104 of the products they selected. Terms of a second supplier offer are shown in offer detail area 2114. Here, these include unit price, shipping and handling, delivery type, estimated delivery date, and others, as appropriate. A user can interact with the user interface in order to accept the offer or decline the offer. Here, this includes swiping toward 2112 to the left to decline an offer or swiping toward 2110 to accept the offer. In some embodiments, buttons can be provided at 2110 or 2112 that the user can interact with. The user can also select additional items by selecting a continue shopping button 2106 or go to a checkout screen by selecting a checkout button 2108. Further, a user can select a “compare offer” button 2116, in order to compare an offer with another offer.

FIG. 22 is an example embodiment of a user interface offer screen 2200. In the example embodiment, terms of a first and second Supplier Offer are shown in fields 2202 and 2204 respectively. Here, these include unit price, shipping and handling, delivery type, estimated delivery date, and others, as appropriate. A user can interact with the user interface in order to compare these terms for multiple offers and accept or decline the offer(s) by selecting appropriate buttons 2212 or swiping one or more offers away. Differences between the offers are also shown in differences field 2210. The user can also select additional items by selecting a continue shopping button 2206 or go to a checkout screen by selecting a checkout button 2208.

FIG. 23 is an example embodiment of a user interface review current order totaling screen 2300. As shown in the example embodiment, a user can view images 2302 of products they have captured as well as quantities 2304 of the products they selected. They can choose to continue shopping by selecting a “Continue Shopping” button 2306 (see FIG. 18 and associated description) or choose to end the current session and purchase the products by selecting a “Checkout” button 2308. A totaling processing icon 2310 can indicate that the total price of the order is being processed by the system, after the user selects Checkout button 2308. Once processed, the user interface can display a current order summary screen, as shown in FIG. 24.

FIG. 24 is an example embodiment of a user interface current order summary screen 2400. As shown in the example embodiment, a user can view order details such as product name, quantity, individual price, and total quantity price in an order details area 2402. Users can view an order summary including a number of items in the order, a card or other payment method to be charged, a subtotal, taxes, system use fee and grand total in an order summary total 2404. Users can them complete the order by selecting a complete order button 2406 (see FIG. 22 and associated description). In many embodiments, various options can be changed by either selecting them and updating appropriate information or by selecting a back button or a cart button, neither of which are shown in FIG. 21. If a user wants to review the order further or edit it, they can select a back button 2408, which will take them to an order summary screen (see FIG. 23).

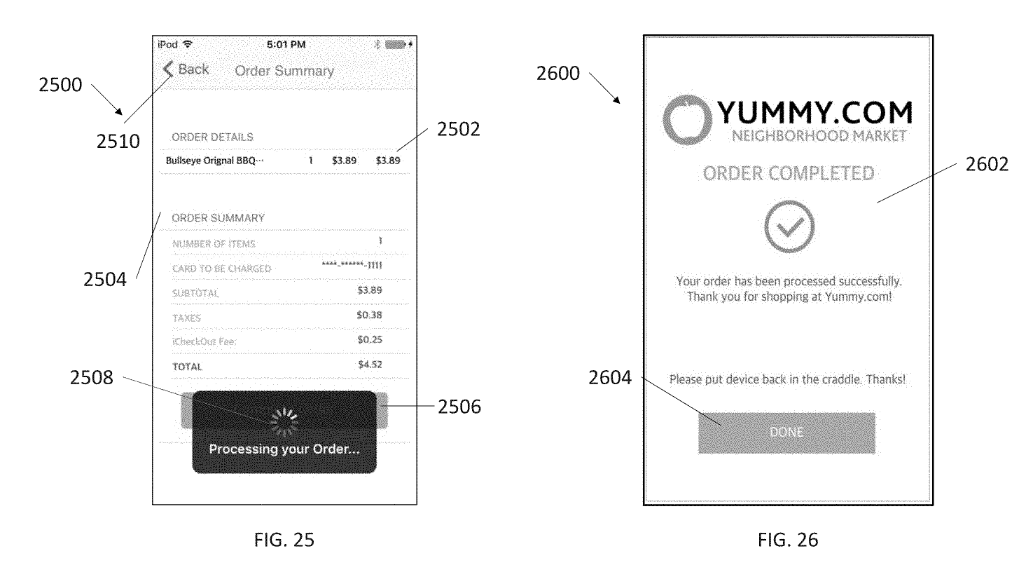

FIG. 25 is an example embodiment of a user interface current order processing screen 2500. As shown in the example embodiment, a user can view order details such as product name, quantity, individual price, and total quantity price in an order details area 2502. Users can view an order summary including a number of items in the order, a card or other payment method to be charged, a subtotal, taxes, system use fee and grand total in an order summary total 2504. Users can them complete the order by selecting a complete order button 2506 (see FIG. 22 and associated description). In many embodiments, various options can be changed by either selecting them and updating appropriate information or by selecting a back button or a cart button, neither of which are shown in FIG. 21. If a user wants to review the order further or edit it, they can select a back button 2510, which will take them to an order summary screen (see FIG. 23). An order processing icon 2508 indicates that the order is being processed by the system.

FIG. 26 is an example embodiment of a user interface current order complete confirmation notification screen 2600. As shown in the example embodiment, an alternative to the user interface current, provides information 2602 about a completed order. Thank you for shopping at Yummy.com! Please put device back in the cradle. Thanks!” The user can then select an acknowledgement button, here in the form of a “Done” button 2604. In some embodiments, a back or review order button can be selected that allows a user to review an order.

In some embodiments, specialized user devices can be provided in a retail store. These can include user interfaces, processors, non-transitory memory, cameras or scanners, batteries, networking interfaces, and various other components that are operable to provide the functionality described herein. As such, users can pick up these user devices and use them when in a store. When a user is ready to leave the store, the device may display an electronic receipt on the user interface that can be shown to a store employee who can confirm the items in the order. In some embodiments, the electronic receipt can be transmitted to a network connected printer via the network in order to print a hard copy of the receipt for the user, the store or both.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method for providing dynamic fee structure selection associated with an online merchant to a customer via a user device that is communicatively coupled to a computer network, comprising:
instructions stored in non-transitory computer readable memory that, when executed by a processor of the user device, cause the user device to perform the steps of:
creating or accessing a user account by communicating with a server via the computer network;
selectively displaying, via a graphical user interface of the user device:
a dynamic first fee structure offer associated with an online transaction between the customer and the merchant received from the server; and
a user selectable option to accept the dynamic first fee structure offer,
wherein, if the user selects the option to accept the first fee structure offer via a user interface of the device performs the steps of:
transmitting the offer acceptance and information associated with the online transaction to the server via the network for storage in non-transitory memory and processing by the online merchant; and
selectively displaying a transaction and offer acceptance confirmation to the user via the graphical user interface.

2. The method of claim 1, wherein upon accessing the user account via the network, the server:
checks at least one current fee structure option for the online merchant;
compares the current fee structure option with a customer fee structure option stored in non-transitory memory and associated with the customer to determine if they match; and
selectively transmits one or more offers based on a current customer fee structure option for display on the user device.

3. The method of claim 2, wherein if, after comparing, the server determines there is not a match between the current fee structure option and the customer fee structure option, the server selectively calculates a current customer fee structure option for the customer prior to selectively transmitting one or more offers to the customer via the network for display on the user device.

4. The method of claim 2, wherein if, after comparing, the server determines there is a match between the current fee structure option and the customer fee structure option, the server sets the customer fee structure option as the current customer fee structure option.

5. The method of claim 2, further comprising:
the server storing the current customer fee structure in non-transitory memory upon completion of the transaction for use in a subsequent transaction.

6. The method of claim 2, wherein the server transmits a dynamic second fee structure option to the user device via the network for display on the graphical user interface.

7. The method of claim 1, wherein the graphical user interface further displays at least one additional fee structure offer.

8. The method of claim 7, wherein the graphical user interface displays the at least one additional fee structure offer concurrently with the first fee structure offer.

9. The method of claim 7, wherein the graphical user interface displays the at least one additional fee structure offer if the user declines the first fee structure offer.

10. The method of claim 1, wherein the first dynamic fee structure offer is based on a review of customer transaction terms.

11. The method of claim 10, wherein, if the customer does not select the option to accept the dynamic first fee structure offer, the online merchant receives a notification that the customer has declined the first fee structure offer.

12. The method of claim 10, wherein, if the customer does not select the option to accept the dynamic first fee structure offer, the device will transmit a counteroffer created by the customer using the user interface to the online merchant for review.

13. A system for providing dynamic fee structure offers associated with an online merchant to a customer via a user device that is communicatively coupled to a computer network, comprising:
a network connected server, comprising:
an account database stored in non-transitory memory of a server; and
a processor;
a network connected user device, comprising:
a processor; and
non-transitory computer readable memory storing instructions that, when executed by the user device processor, cause the user device to:
create or access a user account for an associated user on the server via the computer network;
selectively display, via a graphical user interface of the user device:
a dynamic first fee structure offer associated with an online transaction between the customer and the merchant received from the server; and
a user selectable option to accept the dynamic first fee structure offer,
wherein, if the user selects the option to accept the first fee structure offer via a user interface of the device, the device:
transmits the offer acceptance and information associated with the online transaction to the server via the network for storage in non-transitory memory and processing by the online merchant; and
selectively displays a transaction and offer acceptance confirmation received from the server.

14. The system of claim 13, further comprising:
the server checking at least one current fee structure option for the online merchant;
comparing the current fee structure option with a customer fee structure option stored in non-transitory memory and associated with the customer to determine if they match; and
selectively transmitting one or more offers based on a current customer fee structure option for display on the user device.

15. The system of claim 14, wherein if, after comparing, the server determines there is not a match between the current fee structure option and the customer fee structure option, the server:
selectively calculates a current customer fee structure option for the customer prior to selectively transmitting one or more offers to the customer via the network for display on the user device.

16. The system of claim 14, wherein if, after comparing, the server determines there is a match between the current fee structure option and the customer fee structure option, the server:
sets the customer fee structure option as the current customer fee structure option.

17. The system of claim 14, further comprising:
the server storing the current customer fee structure in non-transitory memory upon completion of the transaction for use in a subsequent transaction.

18. The system of claim 14, wherein the server transmits a dynamic second fee structure option to the user device via the network for display on the graphical user interface.

19. The system of claim 14, wherein the graphical user interface further displays at least one additional fee structure offer.

20. The system of claim 14, wherein the graphical user interface displays the at least one additional fee structure offer concurrently with the first fee structure offer.
